(19) United States
(12) Patent Application Publication
(10) Pub. No.: US 2006/0041367 A1
(43) Pub. Date: Feb. 23, 2006

(54) Vehicle stabilizing control apparatus

(75) Inventors: Eiichi Ono, Toyota-shi (JP); Tomoko Abe, Susono-shi (JP); Yuji Muragishi, Owariasahi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOYOTA CHUO KENKYUSHO, Aichi-gun (JP)

(21) Appl. No.: 11/205,096

(22) Filed: Aug. 17, 2005

(30) Foreign Application Priority Data
Aug. 18, 2004 (JP) 2004-238516

(51) Int. Cl. B60T 7/12

(52) U.S. Cl. 701/75

(57) ABSTRACT

A vehicle stabilizing control apparatus is disclosed which includes a vehicle velocity sensor, an angular velocity sensor, and a lateral acceleration sensor that detects a lateral acceleration of the vehicle or a steering angle sensor that detects a steering angle. The angular velocity sensor detects an angular velocity about an axis defined by inclining a vertical upward or downward axis of a vehicle at a predetermined angle in the forward or rearward direction of the vehicle.

### CROSS REFERENCE TO RELATED APPLICATION

This application claims priority under 35 USC 119 from Japanese Patent Application No. 2004-238,516, the disclosure of which is incorporated by reference herein.

### BACKGROUND OF THE INVENTION

1. Field of the Invention

The present invention relates to a vehicle stabilizing control apparatus, and more particularly to a vehicle stabilizing control apparatus capable of simultaneously achieving not only spin suppression but also rollover prevention by performing spin suppressing control using a single angular velocity sensor in lieu of a yaw angular velocity sensor and a roll angular velocity sensor.

2. Description of the Related Art

Known in the art is a technique for determining whether or not a roll motion has a tendency to diverge, based on signals representing a roll angle and roll angular velocity of vehicle motion, in order to prevent rollover of the vehicle (refer to JP-A No. 2001-71787). However, in this known technique, it is necessary to detect two physical quantities such as roll angle and roll angular velocity.

Also known in the art is a technique for preventing rollover of a vehicle without detecting a roll angle or a roll angular velocity, wherein a roll angle is estimated by comparing a yaw angular velocity detected by a yaw angular velocity sensor, a lateral acceleration estimated from a vehicle velocity, and a lateral acceleration detected by a lateral acceleration sensor, and a determination about vehicle rollover is made based on the estimated roll angle (refer to JP-A No. 11-258260).

However, in the known technique mentioned just above, although a roll angle can be estimated from a yaw angular velocity and lateral acceleration, a roll angular velocity cannot be estimated. Thus, it is required that a determination about rollover be made either based on a roll angle alone or on an estimated roll angle and a roll angular velocity estimated by differentiating the estimated roll angle with respect to time. For this reason, there are problems such that the determination is delayed by a time that is taken to estimate the roll angular velocity and the accuracy of the determination about rollover is decreased due to noise contained in a roll angular velocity estimated value based on the differential calculation.

### SUMMARY OF THE INVENTION

The prevent invention has been made in order to eliminate the above-mentioned problems and provides a vehicle stabilizing control apparatus capable of preventing occurrence of phenomena such as spin and rollover, without making a distinction between the two, using a single angular velocity sensor.

A first aspect of the present invention provides a vehicle stabilizing control apparatus comprising: a vehicle velocity sensor; an angular velocity sensor that detects an angular velocity about an axis defined by inclining a vertical upward or downward axis of a vehicle at a predetermined angle in a forward or backward direction of the vehicle; and a lateral acceleration sensor that detects a lateral acceleration of a vehicle, or a steering angle sensor that detects a steering angle of the vehicle.

A second aspect of the present invention provides a vehicle stabilizing control apparatus comprising: a vehicle velocity sensor; an angular velocity sensor that detects an angular velocity about an axis defined by inclining a vertical upward or downward axis of a vehicle at a predetermined angle in a forward or backward direction of the vehicle; a lateral acceleration sensor that detects a lateral acceleration of the vehicle, or a steering angle sensor that detects a steering angle of the vehicle; a roll angular velocity estimating unit that estimates a roll angular velocity of the vehicle based on the lateral acceleration detected by the lateral acceleration sensor, or a steering angle detected by the steering angle sensor, and a vehicle velocity detected by the vehicle velocity sensor; a yaw angular velocity transforming unit that transforms the angular velocity detected by the angular velocity sensor to a transformed value of a yaw angular velocity based on the angular velocity detected the angular velocity sensor, an estimated value of the roll angular velocity, and the predetermined angle on an assumption that the roll angular velocity corresponds with the estimated value of the roll angular velocity estimated by the roll angular velocity estimating unit; and a control unit that performs a control for stabilizing the vehicle based on the vehicle velocity detected by the vehicle velocity sensor, the transformed value of the yaw angular velocity transformed by the yaw angular velocity transforming unit, and the lateral acceleration detected by the lateral acceleration sensor; wherein, based on a relationship described by an equation ω=p sin θ+r cos θ wherein ω is the angular velocity detected by the angular velocity sensor, θ is the predetermined angle, r is a yaw angular velocity and p is a roll angular velocity and the yaw angular velocity r and the roll angular velocity p are angular velocity elements representing a rotational motion of the vehicle, destabilization of the lateral acceleration and one or more of the angular velocity elements is suppressed; wherein the control unit performs spin suppressing control using a vehicle slip angular velocity computed using the vehicle velocity, lateral acceleration and transformed value of the yaw angular velocity and a vehicle slip angle computed from the vehicle slip angular velocity.

A third aspect of the present invention provides a vehicle stabilizing control apparatus comprising: a vehicle velocity sensor; an angular velocity sensor that detects an angular velocity about an axis defined by inclining a vertical upward or downward axis of a vehicle at a predetermined angle in a forward or backward direction of the vehicle; a lateral acceleration sensor that detects a lateral acceleration of a vehicle, or a steering angle sensor that detects a steering angle of the vehicle; a first angular velocity element estimating unit that estimates a first angular velocity element representing a rotational motion of the vehicle based on the lateral acceleration detected by the lateral acceleration sensor, or the steering angle detected by the steering angle sensor and a vehicle velocity detected by the vehicle velocity sensor; a second angular velocity element transforming unit that transforms the angular velocity detected by the angular velocity sensor to a transformed value of a second angular velocity element perpendicular to the first angular velocity element based on the angular velocity detected by the angular velocity sensor, the estimated value of the first angular velocity element, and the predetermined angle on an assumption that the first angular velocity element corresponds with the estimated value estimated by the first angular velocity element estimating unit; and a control unit that performs control for stabilizing the vehicle based on the vehicle velocity detected by the vehicle velocity sensor, the transformed value of the second angular velocity element transformed by the second angular velocity element transforming unit, and the detected lateral acceleration or steering angle; wherein, based on a relationship described by an equation ω=p sin θ+r cos θwherein ω is the angular velocity detected by the angular velocity sensor, θ is the predetermined angle, r is a yaw angular velocity and p is a roll angular velocity and the yaw angular velocity r and the roll angular velocity p are angular velocity elements representing a rotational motion of the vehicle, destabilization of the lateral acceleration and one or more of the angular velocity elements is suppressed; wherein the control unit performs spin suppressing control using a vehicle slip angular velocity computed using the vehicle velocity, lateral acceleration and transformed value of the yaw angular velocity and a vehicle slip angle computed from the vehicle slip angular velocity.

Other aspects, features and advantages of the present invention will become apparent from the following description taken in conjunction with the accompanying drawings.

### BRIEF DESCRIPTION OF THE DRAWINGS

Preferred embodiments of the present invention will be described in detail based on the following figures, in which:

FIG. 1 is a block diagram showing an embodiment of the present invention;

FIG. 2 is a view showing the directions of respective axes useful for explaining about vehicle motion;

FIG. 3 is a diagram illustrating a spin-suppressing control region.

FIG. 4 is a graph showing variations with time of the steering angles of respective vehicles when spin and roll suppressing control is performed;

FIG. 5 is a graph showing variations with time of the lateral accelerations of respective vehicles when spin and roll suppressing control is performed;

FIG. 6 is a graph showing variations with time of the roll angular velocities of respective vehicles when spin and roll suppressing control is performed;

FIG. 7 is a graph showing variations with time of the yaw angular velocities of respective vehicles when spin and roll suppressing control is performed;

FIGS. 8A to 8C are state-transition views of the slip angle β and slip angular velocity β_{d} during running of vehicles A to C respectively.

### DETAILED DESCRIPTION OF THE INVENTION

Embodiments of the present invention will be described in detail with reference to the drawings.

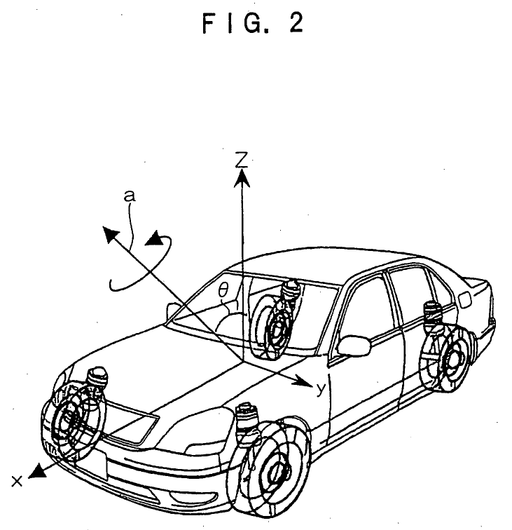

Firstly, as shown in FIG. 2, when it is assumed that the x-axis, y-axis and z-axis extend from the center of gravity of the vehicle and shows motions in the forward direction, leftward direction and vertical upward direction of the vehicle respectively.

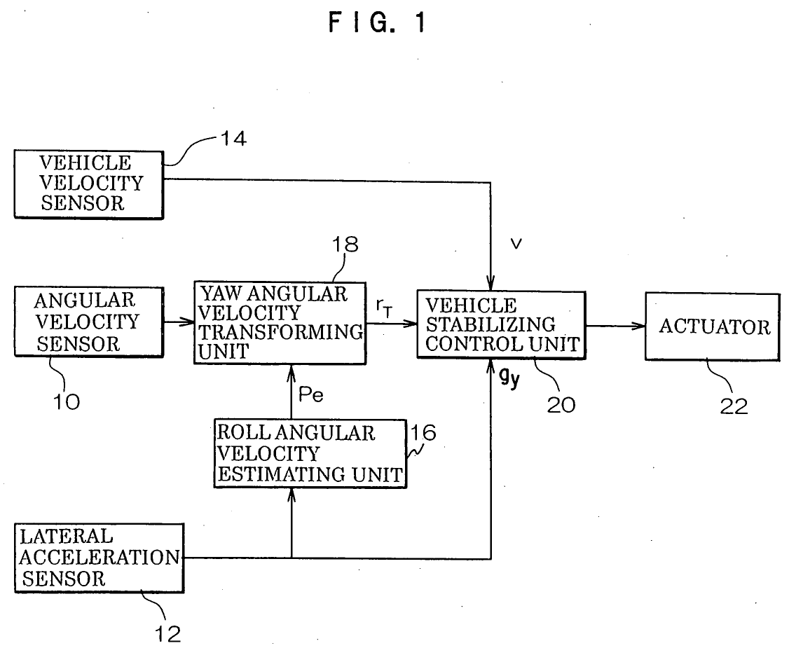

As shown in FIG. 1, in the present embodiment, there are provided: an angular velocity sensor 10, that detects an angular velocity ω about an a-axis defined by inclining a vertical upward axis of the vehicle (for example, z-axis) at a predetermined angle θ in the forward direction of the vehicle (in the direction of the x-axis when the vertical upward axis of the vehicle is the z-axis); a lateral acceleration sensor 12, that detects a lateral acceleration of the vehicle, and a vehicle velocity sensor 14 that detects of a velocity of the vehicle. Meanwhile, the a-axis may be provided either in the x-z plane or a plane parallel to the x-z plane.

The lateral acceleration sensor 12 is connected to a roll angular velocity estimating unit 16, that estimates an estimated value pₑ of the roll angular velocity of the body based on a lateral acceleration g_{y} detected by the lateral acceleration sensor 12, and to a vehicle stabilizing control unit 20.

The angular velocity sensor 10 and the roll angular velocity predicting unit 16 are connected to a yaw angular velocity transforming unit 18, that transforms an angular velocity sensor output into a transformed value r_{T} of the yaw angular velocity based on the angular velocity sensor output ω, the estimated value pₑ of the roll angular velocity, and a predetermined angle θ.

Further, the vehicle velocity sensor 14 and the yaw angular velocity transforming unit 18 are connected to the input terminal of the vehicle stabilizing control unit 20, and an actuator 22 for controlling the front wheel damping force is connected to the output terminal of the vehicle stabilizing control unit 20.

The roll angular velocity estimating unit 16, the yaw angular velocity transforming unit 18, and the vehicle stabilizing control unit 20 according to the embodiment of the present invention are formed, either wholly or individually, by a single microcomputer.

The operation of this embodiment will be described below.

The following relationship holds between an angular velocity ω (sensor output) detected by the angular velocity sensor 10, a yaw angular velocity r, and a roll angular velocity p:
ω=p sin θ+r cos θ (1)

Next, explanation is made of the estimation of the roll angular velocity by the roll angular velocity estimating unit 16. In a linear region in which both the left and right wheels are in sufficient contact with a ground surface, the roll angular velocity p can be approximated by the following equation (2)

$$p = \frac{mhs}{{I}_{x} {s}^{2} + {C}_{x} s + {K}_{x}} {g}_{y} \qquad ( 2 )$$

where m is a vehicle mass; h is the height of a vehicle's center of gravity; Iₓ is a rolling inertia; Cₓ is a rolling viscosity; Kₓ is a rolling rigidity; and s is the Laplace operator.

The above equation (2) can be computed in a computer through discretizaton by the Tustin transformation. The Tustin transformation can be described by equation (3) given below, where T is a sampling time, and z is a time progression operator. By substituting the equation (3) into the equation (2), the roll angular velocity can be discretized as shown by equation (4) given below.

$$\begin{matrix}s = \frac{2 ( z - 1 )}{T ( z + 1 )} & ( 3 ) \\ \begin{matrix}p = \frac{mh \cdot 2 ( z - 1 ) \cdot T ( z + 1 )}{{I}_{x} \cdot 4 {( z - 1 )}^{2} + {C}_{x} \cdot 2 ( z - 1 ) \cdot T ( z + 1 ) + {K}_{x} \cdot {{T}^{2} ( z + 1 )}^{2}} {g}_{y} \\ = \frac{2 mh ( {z}^{2} - 1 )}{( 4 {I}_{x} + 2 {TC}_{x} + {T}^{2} {K}_{x} ) {z}^{2} + ( - 8 {I}_{x} + 2 {T}^{2} {K}_{x} ) z + 4 {I}_{x} - 2 {TC}_{x} + {T}^{2} {K}_{x}} {g}_{y}\end{matrix} & ( 4 )\end{matrix}$$

The roll angular velocity estimating unit 16 carries out a computation of the above equation (4) and outputs the result of the computation as the roll angular velocity estimated value pₑ.

Assuming here that the roll angular velocity p corresponds with the roll angular velocity estimated value pₑ, namely that both the left and right wheels are in sufficient contact with the ground surface and rolling motions are being executed in the linear region, the sensor output ω can be transformed to a yaw angular velocity as shown in the following equation (5):

$${r}_{T} = \frac{ω - {p}_{e} sin θ}{cos θ} \qquad ( 5 )$$

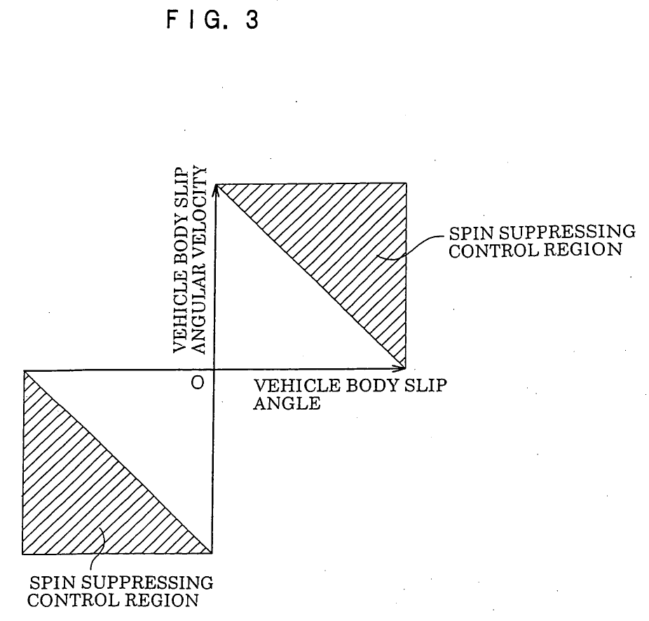

By performing vehicle stabilizing control in the yaw direction based on the yaw angular velocity transformed value r_{T} and the lateral acceleration g_{y}, it is possible to achieve spin and drift suppressing performance equivalent to that achieved when an actual measurement of the yaw angular velocity is used. For example, by estimating the vehicle slip angle β and the vehicle slip angular velocity β_{d} from the vehicle speed v, the yaw angular velocity transformed value r_{T}, and the lateral acceleration g_{y}; determining whether or not the conditions are within a spin suppressing control region, as shown in FIG. 3; and, controlling the actuator when in the spin suppressing control region, the outer of the front wheels relative to the turn is damped so that spin suppressing control can be performed (refer to Japanese Patent No. 3,303,500, the disclosure of which is incorporated by reference herein).

It is determined whether or not the absolute value of a sum of the vehicle slip angle β and the vehicle slip angular velocity is equal to or greater than a predetermined value, and a region in which the absolute value of the sum is equal to or greater than the predetermined value can be regarded as the spin suppressing control region.

Further, the vehicle slip angular velocity β_{d} can be computed from the following equation (6) using the vehicle speed v, and the vehicle slip angle β computed by integrating the vehicle slip angular velocity.

$${β}_{d} = \frac{{g}_{y}}{v} - {r}_{T} \qquad ( 6 )$$

Meanwhile, an approach by amalgamation of model-based estimation and integration, for suppressing drift resulting from integration, is effective in order to increase the computation accuracy of the vehicle slip angle (refer to Japanese Patent No. 3,344,648, the disclosure of which is incorporated by reference herein).

Further, when the rolling motion deviates from the linear region, the following equation (7) is obtained from equations (1) and (5), and thus the yaw angular velocity transformed value r_{T} is expressed by an addition of a roll component (p−pₑ) tan θ to the true value r of the yaw angular velocity.
r_{T}=r+(p−pₑ)tan θ (7)

The equation (7) shows that the yaw angular velocity transformed value r_{T} becomes greater than the yaw angular velocity true value r since the added roll component is increased when the roll angular velocity true value p becomes greater than the roll angular velocity estimated value pₑ due to an increased possibility of rollover.

Meanwhile, as can be seen from the equation (6), if the yaw angular velocity transformed value r_{T} is increased, then both the vehicle slip angular velocity β_{d} and the vehicle slip angle β are decreased, and thus the increase in the yaw angular velocity transformed value r_{T} corresponds to an increase in the vehicle slip angular velocity β and an increase in the vehicle slip angle β of reverse sign. For this reason, when the roll angular velocity true value p becomes greater than the roll angular velocity estimated value p_{e,} due to an increased possibility of rollover, both the vehicle slip angular velocity β_{d} and the vehicle slip angle β are increased in a negative direction, and thus it becomes likely that the operation enters the spin suppressing control region shown in FIG. 3.

Here, application of a damping force to the outer of the front wheels relative to a turn causes an outward moment to be applied to the vehicle, thereby producing not only a spin-suppressing effect but also a roll-suppressing effect. Thus, when the roll angular velocity true value p becomes greater than the roll angular velocity estimated value pₑ due to an increased possibility of rollover, a control to apply a damping force to the turning outer wheel of the front wheels works such that the occurrence of roll is suppressed, i.e., the occurrence of rollover is prevented.

As described above, according to the embodiment of the present invention, the angular velocity sensor for vehicle stabilizing control is mounted so as to detect an angular velocity about an axis defined by inclining a vertical upward axis of the vehicle a predetermined angle in the forward direction of the vehicle, and the yaw angular velocity transformed value obtained by transforming the output of the angular velocity sensor to a yaw angular velocity is used for the vehicle stabilizing control to suppress the occurrence of spin, thereby making it possible to simultaneously suppress not only the occurrence of spin but also the occurrence of rollover.

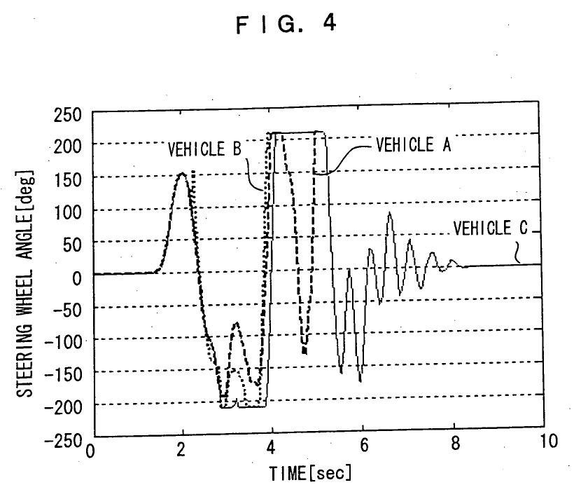

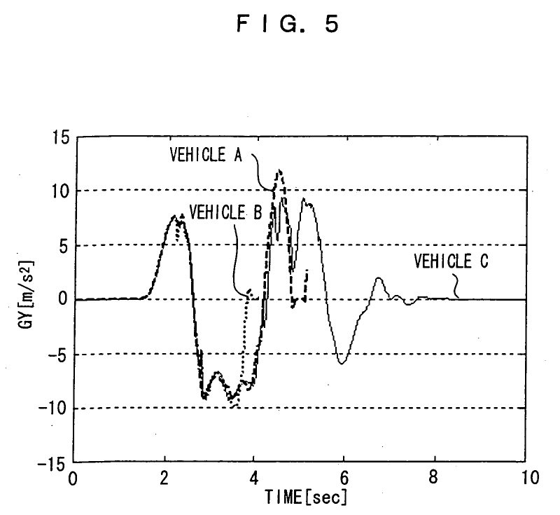

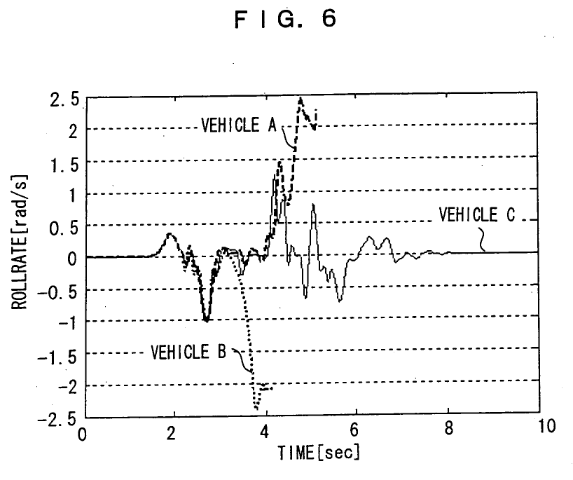

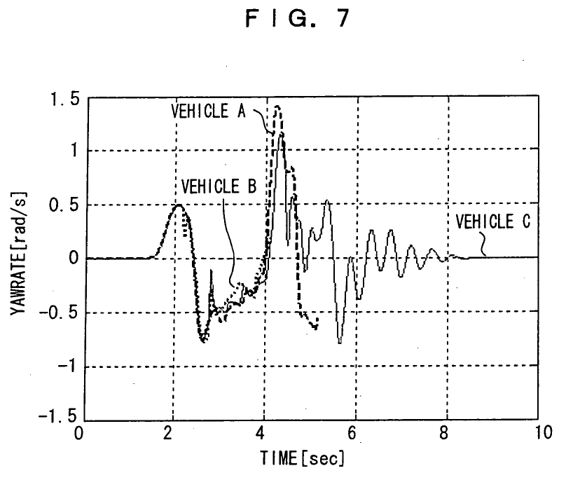

Referring now to FIGS. 4 to 8, there are shown manners in which the occurrence of rollover during a double lane change at a vehicle speed of 100 km/h is prevented, as examples of spin and roll suppressing control. In FIGS. 4 to 8, vehicle A is a vehicle which performs no control; vehicle B is a vehicle which performs conventional spin suppressing control; and vehicle C is a vehicle which performs the spin and roll suppressing control in accordance with the present invention. The angular velocity sensor 10 of the vehicle C is set at an axis which corresponds to the z-axis in FIG. 2 which has then been inclined 30 degrees in the x-direction.

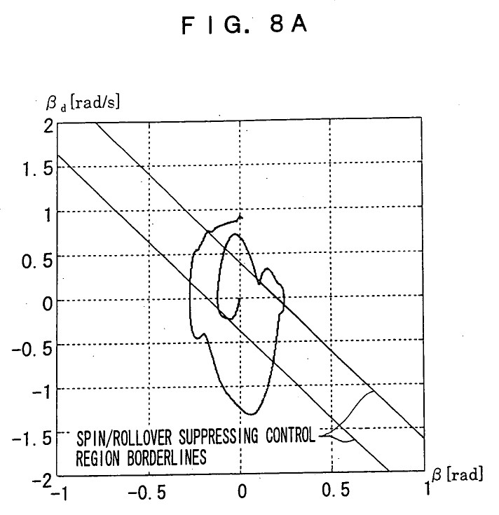

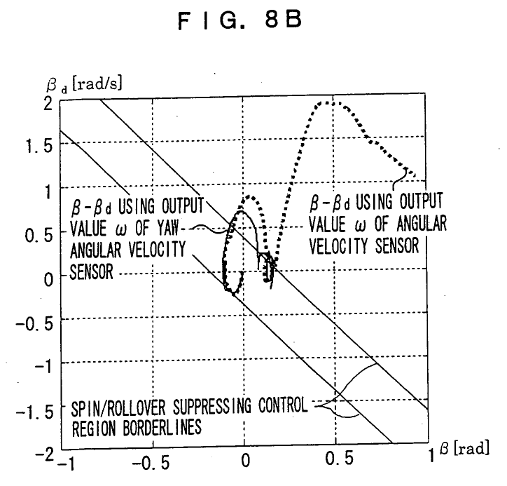

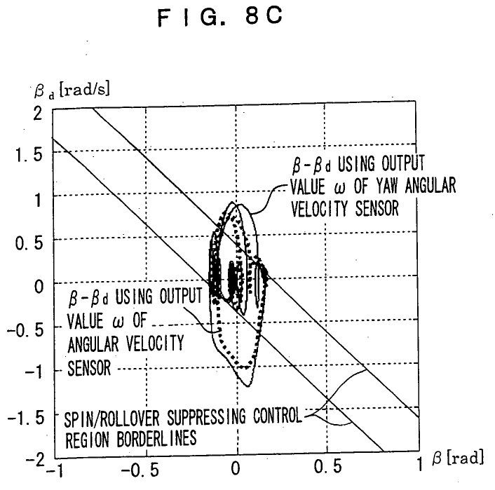

FIGS. 4 to 7 show variations with time of the steering angle, lateral acceleration, roll angular velocity and yaw angular velocity. The vehicles A and B are rolled over due to an increase in the roll angle, while the vehicle C is prevented from being rolled over by suppressing the roll tendency. FIGS. 8A to 8 C are state transition diagrams of the slip angle β and slip angular velocity β_{d} during running of the vehicles A to C. The vehicle stabilizing control works outside rollover suppressing control region borderlines represented by two straight lines. In the vehicle B, when the state of β−β_{d} is computed using an angular velocity obtained from the yaw angular sensor, it may happen that the operation fails to enter the control region irrespective of an increased roll tendency of the vehicle so that no vehicle stabilizing control is performed, which leads to rollover. In such a case, if the state of β−β_{d} is computed using an angular velocity ω obtained from an inclined sensor, it can be seen that the operation enters the control region. This indicates that it becomes easier to estimate a destabilzing tendency of the vehicle by compution of β−β_{d} based on an angular velocity ω obtained from the inclined sensor. In the case of the vehicle C, it is shown that since the state of β−β_{d} based on an angular velocity ω is also in the normal region, stabilizing control is effectively performed.

Although in the foregoing, description has been made of the example in which a detected lateral acceleration is used in estimating a roll angular velocity, it is also possible to detect a steering angle and a vehicle velocity and use a roll angular velocity estimated based on the detected steering angle and vehicle velocity. Further, it is also possible that an angular velocity about an axis defined by inclining a vertical downward axis of the vehicle a predetermined angle in the rearward direction of the vehicle may be detected by the angular velocity sensor.

While the present invention has been illustrated and described with respect to specific embodiments thereof, it should be understood that the present invention is by no means limited thereto and encompasses all changes and modifications which will become possible within the scope of the appended claims.

What is claimed is:

1. A vehicle stabilizing control apparatus comprising:
a vehicle velocity sensor;
an angular velocity sensor that detects an angular velocity about an axis defined by inclining a vertical upward or downward axis of a vehicle at a predetermined angle in a forward or backward direction of the vehicle; and
a lateral acceleration sensor that detects a lateral acceleration of a vehicle, or a steering angle sensor that detects a steering angle of the vehicle.

2. The apparatus of claim 1, wherein, based on a relationship described by an equation ω=p sin θ+r cos θ wherein θ is the angular velocity detected by the angular velocity sensor, θ is the predetermined angle, r is a yaw angular velocity and p is a roll angular velocity and the yaw angular velocity r and the roll angular velocity p are angular velocity elements representing a rotational motion of the vehicle, destabilization of the lateral acceleration and one or more of the angular velocity elements is suppressed.

3. The apparatus of claim 1, further comprising:
a roll angular velocity estimating unit that estimates a roll angular velocity of the vehicle based on a lateral acceleration detected by the lateral acceleration sensor, or a steering angle detected by the steering angle sensor, and a vehicle velocity detected by the vehicle velocity sensor;
a yaw angular velocity transforming unit that transforms the angular velocity detected by the angular velocity sensor to a transformed value of a yaw angular velocity based on the angular velocity detected by the angular velocity sensor, the estimated value of the roll angular velocity, and the predetermined angle on an assumption that the roll angular velocity corresponds with the estimated value of the roll angular velocity estimated by the roll angular velocity estimating unit; and
a control unit that performs control for stabilizing the vehicle based on the vehicle velocity detected by the vehicle velocity sensor, the transformed value of the yaw angular velocity transformed by the yaw angular velocity transforming unit, and the lateral acceleration detected by the lateral acceleration sensor.

4. The apparatus of claim 1 further comprising:
a first angular velocity element estimating unit that estimates a first angular velocity element representing a rotational motion of the vehicle based on the lateral acceleration detected by the lateral acceleration sensor, or the steering angle detected by a steering angle sensor, and a vehicle velocity detected by the vehicle velocity sensor;
a second angular velocity element transforming unit that transforms the angular velocity detected by the angular velocity sensor to a transformed value of a second angular velocity element perpendicular to the first angular velocity element based on the angular velocity detected by the angular velocity sensor, the estimated value of the first angular velocity element, and the predetermined angle on an assumption that the first angular velocity element corresponds with the estimated value estimated by the first angular velocity element estimating unit; and
a control unit that performs control for stabilizing the vehicle based on the vehicle velocity detected by the vehicle velocity sensor, the transformed value of the second angular velocity element transformed by the second angular velocity element transforming unit, and the detected lateral acceleration or steering angle.

5. The apparatus of claim 3, wherein the control unit performs spin suppressing control using a vehicle slip angular velocity, computed using the vehicle velocity, lateral acceleration and transformed value of the yaw angular velocity, and a vehicle slip angle computed from the vehicle slip angular velocity.

6. The apparatus of claim 4, wherein the control unit performs spin suppressing control using a vehicle slip angular velocity computed using the vehicle velocity, lateral acceleration and transformed value of the yaw angular velocity and a vehicle slip angle computed from the vehicle slip angular velocity.

7. A vehicle stabilizing control apparatus comprising:
a vehicle velocity sensor;
an angular velocity sensor that detects an angular velocity about an axis defined by inclining a vertical upward or downward axis of the vehicle at a predetermined angle in a forward or backward direction of the vehicle;
a lateral acceleration sensor that detects a lateral acceleration of a vehicle, or a steering angle sensor that detects a steering angle of the vehicle;
a roll angular velocity estimating unit that estimates a roll angular velocity of the vehicle based on the lateral acceleration detected by the lateral acceleration sensor, or the steering angle detected by the steering angle sensor, and a vehicle velocity detected by the vehicle velocity sensor;
a yaw angular velocity transforming unit that transforms the angular velocity detected by the angular velocity sensor to a transformed value of a yaw angular velocity based on the angular velocity detected the angular velocity sensor, an estimated value of the roll angular velocity, and the predetermined angle on an assumption that the roll angular velocity corresponds with the estimated value of the roll angular velocity estimated by the roll angular velocity estimating unit; and
a control unit that performs control for stabilizing the vehicle based on the vehicle velocity detected by the vehicle velocity sensor, the transformed value of the yaw angular velocity transformed by the yaw angular velocity transforming unit, and the lateral acceleration detected by the lateral acceleration sensor;
wherein, based on a relationship described by an equation ω=p sin θ+r cos θ wherein ω is the angular velocity detected by the angular velocity sensor, θ is the predetermined angle, r is a yaw angular velocity and p is a roll angular velocity and the yaw angular velocity r and the roll angular velocity p are angular velocity elements representing a rotational motion of the vehicle, destabilization of the lateral acceleration and one or more of the angular velocity elements is suppressed;
wherein the control unit performs spin suppressing control using a vehicle slip angular velocity computed using the vehicle velocity, lateral acceleration and transformed value of the yaw angular velocity and a vehicle slip angle computed from the vehicle slip angular velocity.

8. A vehicle stabilizing control apparatus comprising:
a vehicle velocity sensor;
an angular velocity sensor that detects an angular velocity about an axis defined by inclining a vertical upward or downward axis of the vehicle at a predetermined angle in a forward or backward direction of the vehicle;
a lateral acceleration sensor that detects a lateral acceleration of a vehicle, or a steering angle sensor that detects a steering angle of the vehicle;
a first angular velocity element estimating unit that estimates a first angular velocity element representing a rotational motion of the vehicle based on the lateral acceleration detected by the lateral acceleration sensor, or the steering angle detected by the steering angle sensor, and a vehicle velocity detected by the vehicle velocity sensor;
a second angular velocity element transforming unit that transforms the angular velocity detected by the angular velocity sensor to a transformed value of a second angular velocity element perpendicular to the first angular velocity element based on the angular velocity detected by the angular velocity sensor, the estimated value of the first angular velocity element, and the predetermined angle on an assumption that the first angular velocity element corresponds with the estimated value estimated by the first angular velocity element estimating unit; and
a control unit that performs control for stabilizing the vehicle based on the vehicle velocity detected by the vehicle velocity sensor, the transformed value of the second angular velocity element transformed by the second angular velocity element transforming unit, and the detected lateral acceleration or steering angle;
wherein, based on a relationship described by an equation ω=p sin θ+r cos θ wherein ω is the angular velocity detected by the angular velocity sensor, θ is the predetermined angle, r is a yaw angular velocity and p is a roll angular velocity and the yaw angular velocity r and the roll angular velocity p are angular velocity elements representing a rotational motion of the vehicle, destabilization of the lateral acceleration and one or more of the angular velocity elements is suppressed;
wherein the control unit performs spin suppressing control using a vehicle slip angular velocity computed using the vehicle velocity, lateral acceleration and transformed value of the yaw angular velocity and a vehicle slip angle computed from the vehicle slip angular velocity.
